(19) United States
(12) Patent Application Publication
(10) Pub. No.: US 2024/0150238 A1
(43) Pub. Date: May 9, 2024

(54) PERVIOUS CONCRETE COMPOSITION AND MINERAL MEMBRANE HAVING SAME

(71) Applicant: 12279479 CANADA INC., Charette (CA)

(72) Inventors: Serge BAILLARGEON, Charette (CA); Eric BARD, Shawinigan (CA)

(21) Appl. No.: 18/549,783

(22) PCT Filed: Mar. 10, 2022
(86) PCT No.: PCT/CA2022/050353

§ 371 Date: Sep. 8, 2023

Related U.S. Application Data
(60) Provisional application No. 63/159,261, filed on Mar. 10, 2021.

(51) Int. Cl. C04B 14/02; B01D 71/02; C02F 1/00; C02F 3/20; C02F 11/121; C04B 14/04; C04B 16/06; C04B 28/04; E21B 43/38

(52) U.S. Cl. CPC C04B 14/022; B01D 71/02; C02F 1/001; C02F 3/208; C02F 11/121; C04B 14/048; C04B 16/0633; C04B 28/04; E21B 43/38; C04B 2111/00793

(57) ABSTRACT

A filtering well has a body defining an inner volume, the body having a mineral membrane made of a pervious concrete composition in order to filter water flow into the inner volume of the body. An outlet conduit is in fluid communication with the inner volume for discharging water therefrom. The outlet conduit is formed in the mineral membrane of the body. Other aspects are also disclosed.

### CROSS-REFERENCE

The present application claims priority from U.S. Provisional Patent Application No. 63/159,261, filed Mar. 10, 2021, the entirety of which is incorporated by reference herein.

### FIELD OF THE TECHNOLOGY

The present technology relates to pervious concrete compositions and uses thereof.

### BACKGROUND

Pervious concrete is a type of concrete that has a high porosity to allow fluids to flow therethrough. For instance, pervious concrete can be used to form concrete ground surfaces to reduce surface runoff and allow groundwater recharge. In other instances, pervious concrete may be used for filtration, such as in pipes.

However, pervious concrete often lacks the structural strength of impervious concrete (i.e., concrete which does not allow fluid to seep therethrough) and therefore its applications can sometimes be limited. Moreover, in some cases, it may be desirable to have a pervious concrete with greater porosity than is otherwise currently available.

Furthermore, such pervious concrete can be used in various applications in which filtering is useful, including for example in the construction of filtering wells. However, such filtering wells can be difficult to install. Other applications may also benefit from using pervious concrete.

Thus, there is a desire for a pervious concrete composition that addresses some of the aforementioned drawbacks.

### SUMMARY

It is an object of the present technology to ameliorate at least some of the inconveniences present in the prior art.

According to an aspect of the present technology, there is provided a filtering well comprising: a body defining an inner volume, the body comprising a mineral membrane made of a pervious concrete composition in order to filter water flow into the inner volume of the body; and an outlet conduit in fluid communication with the inner volume for discharging water therefrom, the outlet conduit being formed in the mineral membrane of the body.

In some embodiments, the body comprises a top wall, a bottom wall and a peripheral wall extending between the top and bottom walls; and the outlet conduit extends from the top wall.

In some embodiments, the outlet conduit extends from the top wall to near the bottom wall; and the outlet conduit comprises a peripheral conduit wall, the peripheral conduit wall defining a plurality of flow openings.

In some embodiments, each of the top wall, the bottom wall and the peripheral wall comprises the mineral membrane.

In some embodiments, the filtering well further comprises a plurality of guide loops connected to the body for moving the filtering well during installation or removal thereof at a well site, the guide loops being configured to receive a sling for hoisting the filtering well.

In some embodiments, the plurality of guide loops include two pairs of guide loops disposed on opposite sides of the filtering well.

In some embodiments, each pair of guide loops includes a lower guide loop and an upper guide loop vertically generally aligned with the lower guide loop.

In some embodiments, the guide loops are cast in the mineral membrane.

In some embodiments, the filtering well further comprises: a pump disposed within the inner volume; and an inner conduit extending within the outlet conduit, the inner conduit being in fluid communication with the pump.

In some embodiments, the filtering well is configured to be submerged in a body of water; and the filtering well further comprises a well seal closing off the outlet conduit; and an inner conduit in communication with the inner volume and extending through the seal cap.

In some embodiments, the body comprises: a first end wall; a second end wall; an outer peripheral wall extending between the first and second end walls, the inner volume of the body being defined by the first end wall, the second end wall and the outer peripheral wall; and an inner peripheral wall extending between the first and second end walls and disposed within the inner volume, each of the first end wall, the second end wall, the outer peripheral wall and the inner peripheral wall comprising the mineral membrane.

In some embodiments, a filtering well system comprises: the filtering well; a well casing fluidly connected to the outlet conduit, the well casing being configured to extend partly above ground; and a well cover disposed at an upper end of the well casing for selectively closing off the upper end of the well casing.

In some embodiments, the filtering well further comprises an inner conduit extending within the outlet conduit and into the well casing, the inner conduit being configured to conduct water out of the inner volume of the filtering well.

In some embodiments, the filtering well further comprises: a diverting conduit disposed outside of the well casing and in fluid communication with the inner conduit; a pitless adapter fluidly communicating the inner conduit with the diverting conduit, the pitless adapter comprising a first portion disposed within the well casing and a second portion disposed partly outside of the well casing; and a handle rod connected to the first portion of the pitless adapter and disposed within the well casing, the handle rod being configured to be handled by a user to connect and disconnect the first and second portions of the pitless adapter, the handle rod being accessible to the user by opening the well cover.

In some embodiments, the filtering well system further comprises a reinforcing bracket connected between the well casing and the diverting conduit to reinforce the diverting conduit.

In some embodiments, the filtering well further comprises a pump disposed in the internal volume; and the filtering well system further comprises: an electrical wiring connected to the pump and extending within the outlet conduit and into the well casing; and an electrical conduit disposed outside of the well casing and extending downward from the well cover, the electrical conduit being in communication with the well casing via the well cover.

In some embodiments, the filtering well system further comprises a layer of filter sand surrounding the filtering well to partially filter water flow into the filtering well and limit clogging of the mineral membrane.

According to another aspect of the present technology, there is provided a method for installing a filtering well at a well site, comprising: providing a filtering well having a body comprising a mineral membrane made of a pervious concrete composition, the filtering well comprising a plurality of guide loops connected to the body, the plurality of guide loops including two pairs of guide loops disposed on opposite sides of the filtering well; threading a sling through both pair of guide loops on the opposite sides of the filtering well such that the sling passes underneath a bottom wall of the filtering well; connecting the sling to a lifting apparatus; hoisting the filtering well; lowering the filtering well onto a support surface in an excavated area; disconnecting the sling from the lifting apparatus; and removing the sling from engagement with the guide loops.

According to another aspect of the present technology, there is provided a pervious concrete composition comprising: a cement binder; at least one coarse aggregate including coke; and a plurality of synthetic microfibers.

In some embodiments, the coke has pores having an effective por size of approximately 150 μm.

In some embodiments, the coke is a first coarse aggregate; and the at least one coarse aggregate further comprises a second coarse aggregate comprising rock material.

In some embodiments, the rock material is crushed stone.

In some embodiments, a content of the first coarse aggregate over a combined coarse aggregate content including the first and second coarse aggregates is approximately 40%.

In some embodiments, the pervious concrete composition further comprises a fine aggregate comprising coke.

In some embodiments, the cement binder is Portland cement.

In some embodiments, the synthetic microfibers are polypropylene microfibers.

In some embodiments, the synthetic microfibers are monofilament microfibers.

In some embodiments, the synthetic microfibers have a length between 0.25 inches and 1.5 inches inclusively.

In some embodiments, a mineral membrane comprises a porous body made of the pervious concrete composition.

According to another aspect of the present technology, there is provided a mineral membrane for use in filtration, comprising: a cementitious porous body comprising: a cement binder; a plurality of lumps of a coarse aggregate united by the cement binder, the coarse aggregate comprising coke; and a plurality of synthetic microfibers reinforcing the cementitious porous body, the cementitious porous body defining a plurality of first pores between the lumps of coarse aggregate and a plurality of second pores defined within the lumps of coarse aggregate, the first pores having a greater effective pore size than the second pores.

According to another aspect of the present technology, there is provided an air diffuser for aerating a body of water, the air diffuser comprising: a cementitious porous body having an outer peripheral surface and an inner peripheral surface, the inner peripheral surface of the porous body defining an internal passage of the air diffuser configured to be fluidly connected to an air source, the cementitious porous body being made of a pervious concrete composition to allow passage of air flowing within the internal passage through the inner peripheral surface and the outer peripheral surface to aerate the body of water within which the air diffuser is placed, the pervious concrete composition comprising: a cement binder; at least one coarse aggregate including coke; and a plurality of synthetic microfibers for reinforcing the pervious concrete composition.

In some embodiments, the cementitious porous body of the air diffuser is molded into shape.

In some embodiments, the cementitious porous body is generally cylindrical.

In some embodiments, the cementitious porous body extends from a first end to a second end and defines respective openings at the first and second ends; the air diffuser further comprises: a first plug disposed at the first end of the cementitious porous body and partially blocking the opening defined at the first end, the first plug defining a first plug aperture opening into the internal passage; and a second plug disposed at the second end of the cementitious porous body and partially blocking the opening defined at the second end, the second plug defining a second plug aperture opening into the internal passage.

In some embodiments, the first plug and the second plug are made of cementitious material.

In some embodiments, the air diffuser of claim further comprises: a first fitting received in the first plug aperture, the first fitting being configured to be removably connected to a first conduit; and a second fitting received in the second plug aperture, the second fitting being configured to be removably connected to a second conduit.

In some embodiments, a density of the air diffuser is greater than 1 g/cm³.

In some embodiments, the cementitious porous body is an outer cementitious porous body; and the air diffuser comprises an inner cementitious porous body disposed within the internal passage, the inner cementitious porous body having a pervious concrete composition different from the pervious concrete composition of the outer cementitious porous body.

In some embodiments, a wastewater treatment system comprises: an aeration tank configured to contain wastewater therein, the aeration tank having a bottom surface; and the air diffuser, the air diffuser being retained in place on the bottom surface of the aeration tank without being anchored thereto.

In some embodiments, the wastewater treatment system further comprises an air compressor fluidly connected to the air diffuser.

According to another aspect of the present technology, there is provided a filter bed comprising: a cage configured to be filled with filtering material; and at least one filtering conduit disposed within the cage, the at least one filtering conduit being configured to be disposed beneath the filtering material, each of the at least one filtering conduit including a mineral membrane having a pervious concrete composition.

In some embodiments, the filtering material is filter sand.

Embodiments of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects, and advantages of embodiments of the present technology will become apparent from the following description, the accompanying drawings, and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a perspective view of a mineral membrane, in the form of a slab, in accordance with an embodiment of the present technology;

FIG. 2 is a detailed view of section A in FIG. 1 showing a pervious concrete composition of the mineral membrane of FIG. 1;

FIG. 3 is a perspective view of an air diffuser in accordance with another embodiment of the present technology;

FIG. 4 is a cross-sectional view of the air diffuser of FIG. 3;

FIG. 5 is a schematic representation of a wastewater treatment system including the air diffuser of FIG. 3;

FIG. 6 is a perspective view of a filtering well in accordance with another embodiment of the present technology;

FIG. 7 is a cross-sectional view of the filtering well of FIG. 6;

FIG. 8A is a perspective view of a connection kit for installing the filtering well of FIG. 6;

FIG. 8B is a cross-sectional view of the connection kit of FIG. 8A;

FIG. 9 is a perspective view of a conduit connector and part of an well casing of the connection kit of FIG. 8A, showing the conduit connector in an exploded configuration and with a section of the well casing removed to expose the inside thereof;

FIG. 10 is a perspective view of a diverting connector, the conduit connector, and part of the well casing of the connection kit of FIG. 8A, showing a section of the well casing removed to expose the inside thereof;

FIG. 11 is a perspective view of the diverting connector and certain other parts of the connection kit of FIG. 8A shown in an exploded configuration;

FIG. 12 is a cross-sectional view of a filtering well system including the filtering well and the connection kit;

FIG. 13 is a perspective view of a filter bed in accordance with another embodiment of the present technology;

FIG. 14 is a perspective view of the filter bed showing a cross-section of a filtering conduit of the filter bed;

FIG. 15 is a cross-sectional view of a multi filter screen in accordance with another embodiment of the present technology;

FIG. 16 is a perspective view of the multi filter screen secured to two floating members in order to install the multi filter screen at a bottom surface of a body of water;

FIG. 17 is a perspective view of the filtering well of FIG. 6, shown attached to a sling for installing the filtering well according to an embodiment of a method of the present technology;

FIG. 18 is a perspective view of a partial cross-section of the filtering well according to an alternative embodiment;

FIG. 19 is a perspective view of a partial cross-section of the filtering well according to another alternative embodiment; and

FIG. 20 is a cross-sectional view of the air diffuser according to an alternative embodiment.

### DETAILED DESCRIPTION

As will be described below, the present technology implements a mineral membrane made of a pervious concrete composition in different applications. Notably, the mineral membrane provides rigid porous articles that are permeable to the passage of liquids and gases therethrough. As such, the mineral membrane can be used for filtering and/or diffusion in various types of processes and applications.

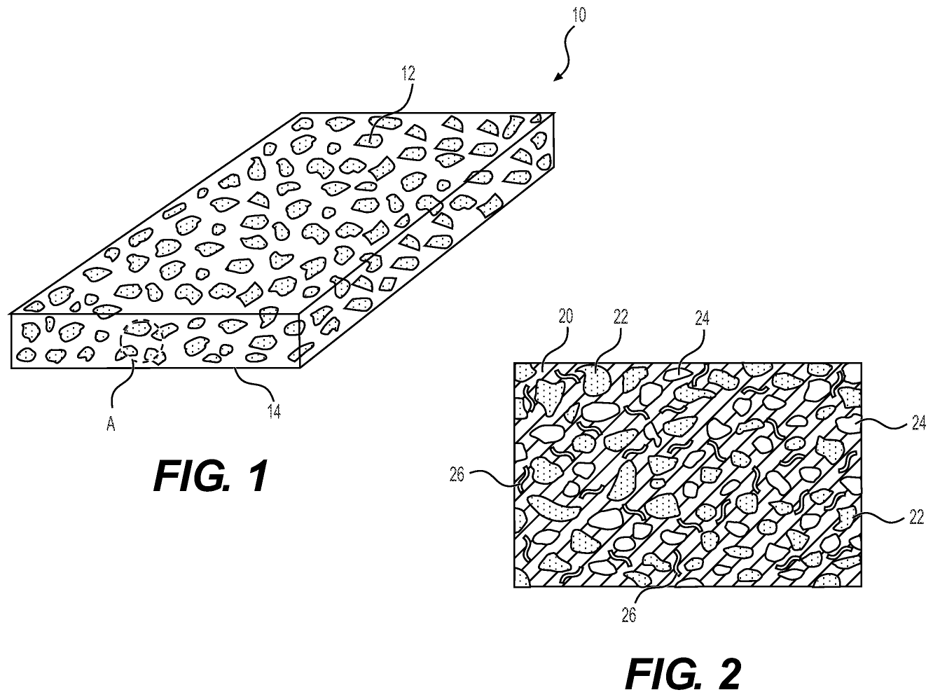

FIG. 1 illustrates a first example of implementation of the mineral membrane of the present technology. Notably, in this embodiment, the mineral membrane is a slab 10 which can be used for rainwater reinfiltration, for landscaping, or for pig slurry management according to some non-limitative examples of applications. As can be seen, in this embodiment, the slab 10 is generally rectangular and has an upper surface 12 and an opposite lower surface 14. In one example of implementation, the slab 10 is installed on a draining material. Due to the porous structure of the slab 10, water permeates through the slab 10, from the upper surface 12 to the lower surface 14. The slab 10 functions as a filter and retains particulate pollutants contained in the water on the upper surface 12 as the water seeps through the slab 10 and through the draining material therebelow.

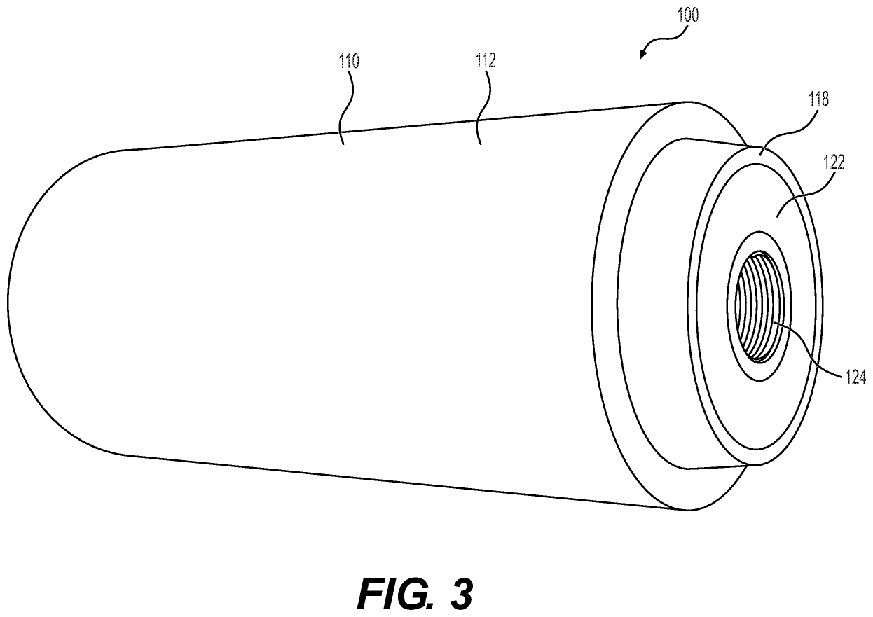

The pervious concrete composition of the mineral membrane, i.e., of the slab 10 in this example, is shown in detail in FIG. 2. In this embodiment, the composition includes a cement binder 20, a plurality of coarse aggregates 22, 24, and a plurality of synthetic microfibers 26, which together form a rigid integral structure. Notably, as can be seen, the coarse aggregates 22, 24 and the synthetic microfibers 26 are coated by the cement binder 20. The resulting structure is a porous body which allows fluids such as water to permeate therethrough. Indeed, the porous body has a “macro” porous structure (i.e., a network of macropores) which corresponds to spaces between lumps of the coarse aggregates 22, 24 and a “micro” porous structure (i.e., a network of micropores) which corresponds to pores of a first coarse aggregate 22, as will be explained in more detail below. As will be appreciated, the size of the spaces between the lumps of coarse aggregates 22, 24 is greater than the size of the pores of the first coarse aggregate 22. The presence of the macro and micro porous structures in the mineral membrane 10 can be particularly useful when the macropores become clogged during use. For instance, when the mineral membrane 10 is used in combination with filter sand (as will be seen in certain applications described further below), the pores of the macro porous structure can become clogged with the filter sand. This can reduce the amount of fluid that can seep through the mineral membrane 10, namely through the macropores. However, since the micropores are smaller and are therefore not susceptible to clogging by the filter sand, they ensure adequate flow through the mineral membrane 10. The micropores thus provide a certain degree of redundancy to the macropores of the macro porous structure.

In a non-limitative example of the pervious concrete composition, for each cubic meter of the mineral membrane, the pervious concrete composition includes approximately 1 part cement binder to 2.5 parts of the coarse aggregates 22, 24. For instance, in this example, for each cubic meter of the mineral membrane, the pervious concrete composition includes approximately 500 kg of the cement binder 20, about 1300 kg of the coarse aggregates 22, 24, and about 0.5 to 3 kg of the synthetic microfibers 26.

The cement binder 20 is a cementitious material which is included in a quantity sufficient to bind the coarse aggregates 22, 24 and the synthetic microfibers 26. In this embodiment, the cement binder 20 is Portland cement. Other cementitious materials are contemplated.

The coarse aggregates 22, 24 provide a granular structure to the mineral membrane. In this embodiment, the first coarse aggregate 22 is coke which is a porous material. As such, the first coarse aggregate 22 may also be referred to as a porous coarse aggregate 22. For instance, coke has an effective pore size of approximately 150 μm which corresponds to the effective pore size of the micro porous structure mentioned above. Furthermore, in this embodiment, the second coarse aggregate 24 is rock material, namely crushed stone. Notably, in this example, the crushed stone 24 is granite having an average size of ¼ inch.

In this embodiment, the proportions of the coke 22 and the crushed stone 24 over a total coarse aggregate content (i.e., the combined contents of the coarse aggregates 22, 24) are approximately 40% and 60% respectively. These proportions may be different in other embodiments. For instance, the proportion of coke 22 may be greater in other embodiments. In some cases, the rock material 24 may even be omitted and the pervious concrete composition may thus only include the coke 22 as a coarse aggregate. However, as coke can be a relatively costly material, its quantity within the pervious concrete composition may be limited in order to limit production costs.

The synthetic microfibers 26 are provided to increase a tensile strength of the mineral membrane. In this embodiment, the synthetic microfibers 26 are monofilament polypropylene fibers. A length of each of the synthetic microfibers 26 may be between 0.25 inch and 1 inch inclusively. A thickness of each of the synthetic microfibers 26 may be less than 0.15 mm. For instance, the thickness of each of the synthetic microfibers 26 may be between 0.05 and 0.1 mm inclusively. Other types of microfibers are contemplated in other embodiments. While such synthetic microfibers have been known to be used in impervious concretes, due to design considerations they are not typically used in pervious concretes. Notably, as pervious concretes are typically used in applications in which tensile strength is not an important attribute (e.g., paving stones), adding such synthetic microfibers is typically perceived as an unnecessary additional cost. In addition, it can be hard to achieve workability of concrete compositions when adding synthetic microfibers. Moreover, as porosity is a principal design consideration for pervious concretes, the addition of the synthetic microfibers 26 to pervious concrete is counterintuitive as it is expected to decrease porosity of the pervious concrete. In fact, the inventors of the present technology were surprised that porosity of the mineral membrane was maintained after addition of the synthetic microfibers 26 in the pervious concrete composition. The inventors have found that the coke 22 which provides additional porosity to the pervious concrete composition compensates for the expected negative effect on porosity of the synthetic microfibers 26. Therefore, the inclusion of both components in the pervious concrete composition results in a highly porous body having greater tensile strength than is typically expected from pervious concretes.

The resulting mineral membrane allows the passage of fluids while filtering particles that are larger than the effective pore size of the mineral membrane. Moreover, the mineral membrane made of the pervious concrete composition provides a lower fluid flow therethrough and decreased particle movement compared to conventional solutions in which an impervious material (e.g., plastic) is provided with openings to form an impervious material membrane. Furthermore, the effective pore size and the structural strength of the mineral membrane can be adjusted based on the ratio of the various components of the pervious concrete composition and as well as the manner in which the mineral membrane is manufactured.

In some embodiments, the pervious concrete composition of the mineral membrane may also include one or more fine aggregates. For example, smaller sized pieces of coke and/or standard concrete sand could be added to impart greater strength to the mineral membrane. If adding smaller sized pieces of coke, the permeability of the mineral membrane would not be reduced by the presence of the smaller sized pieces of coke due to their porosity.

In some embodiments, the pervious concrete composition of the mineral membrane may also include reactive aggregates (e.g., activated carbon). Such reactive aggregates may provide reactive sites for adsorption of particular molecules.

In some embodiments, the pervious concrete composition may also include a dye for imparting a desired color to the mineral membrane.

Other examples of the pervious concrete composition can be found in U.S. Pat. No. 2,303,629, issued Dec. 1, 1942, the entirety of which is incorporated herein by reference.

The mineral membrane 10 with the pervious concrete composition described above can be manufactured in various ways. In this embodiment, the various components of the pervious concrete composition are mixed together and water is added to the mix. The obtained mixed substance is then poured within a mold having a shape of the desired mineral membrane 10 (e.g., rectangular in this embodiment). Pressure can then be applied on the mix to obtain a suitable compaction level which can vary depending on the desired porosity and strength of the mineral membrane 10. Once the material has cured, the molded mineral membrane 10 is removed from the mold. The method of permitting the material to cure is generally referred to herein as “casting”. Additional finishing operations may be carried out in some embodiments.

Other applications of the mineral membrane made of the pervious concrete composition described above will now be described.

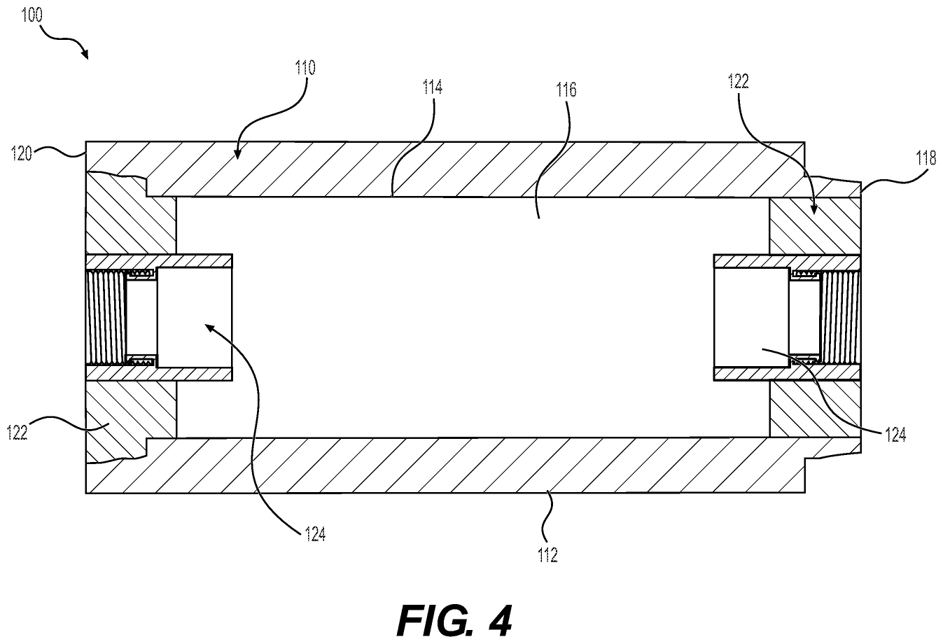

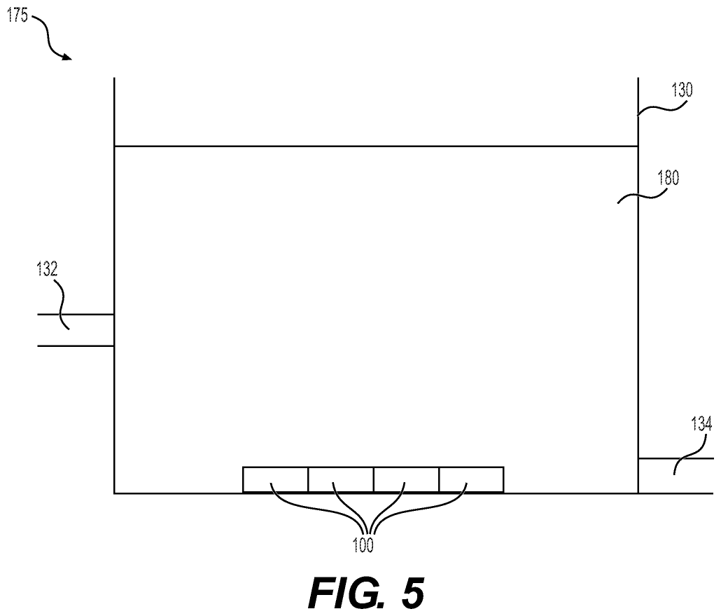

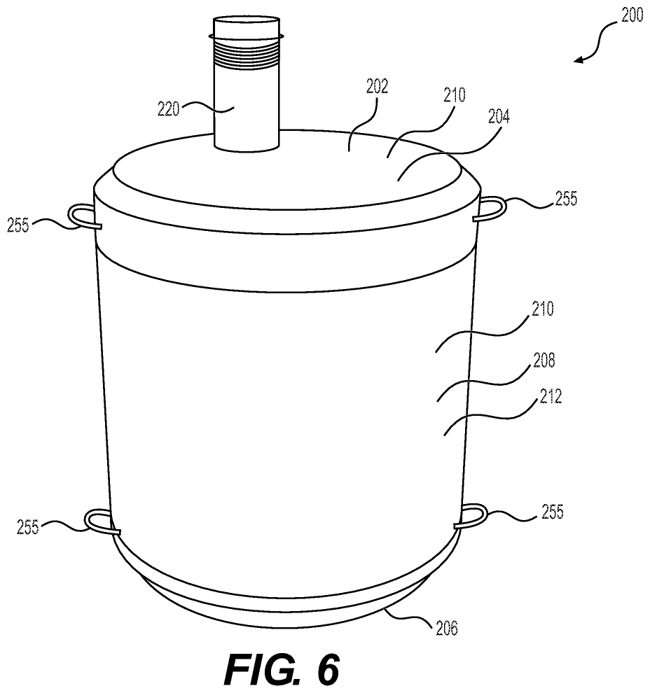

With reference to FIGS. 3 to 5, in some embodiments, an air diffuser 100 configured for aerating a body of water 180 is provided with a mineral membrane 110 having the pervious concrete composition described above. As a result, the air diffuser 100 has a cementitious porous body that is configured for air diffusion as will be described below. In this example of implementation, as shown in FIG. 5, the air diffuser 100 is part of a wastewater treatment system 175.

In this embodiment, the mineral membrane 110 is tubular and generally cylindrical. The mineral membrane 110 has an outer peripheral surface 112 and an inner peripheral surface 114. The inner peripheral surface 114 defines an internal passage 116 of the air diffuser 100. In use, the internal passage 116 is fluidly connected to an air source (not shown) such that air flows through the internal passage 116. The mineral membrane 110 extends from a first end 118 to a second end 120, defining a length of the mineral membrane 110 therebetween. The mineral membrane 110 defines a respective opening at each of the ends 118, 120.

The air diffuser 100 also includes two plugs 122, each disposed at a respective end 118, 120 of the mineral membrane 110 and partially blocking the opening defined at each end 118, 120. Each of the plugs 122 defines a plug aperture that opens into the internal passage 116 of the air diffuser 100. In this embodiment, the plugs 122 are made of a cementitious material. The plug apertures of the plugs 122 receive respective plastic fittings 124 which allows the air diffuser 100 to be connected to an external conduit. Notably, the fittings 124 are threaded to connect to a matching threaded conduit.

As shown in FIG. 5, an exemplary wastewater treatment system 175 implementing the air diffuser 100 includes an aeration tank 130. The aeration tank 130 contains the body of water 180. In this example, the aeration tank 130 is filled with wastewater via an inlet 132, and treated water can be discharged from the aeration tank 130 via an outlet 134. As can be seen, a plurality of the air diffusers 100 are installed within the aeration tank 130, namely positioned on a bottom surface 136 of the aeration tank 130. Notably, as can be seen, a number of the air diffusers 100 are connected in series to circulate air through the air diffusers 100 consecutively. In particular, in this embodiment, the wastewater treatment system 175 includes an air compressor (not shown) that is fluidly connected to the air diffusers 100. In other embodiments, a single air diffuser 100 may be provided.

In use, the aeration tank 130 is filled with wastewater and the air compressor is activated to cause the flow of pressurized air through the air diffusers 100. Due to the porous structure of the mineral membrane 110, the pressurized flow within the internal passage 116 of each air diffuser 100 is diffused through the mineral membrane 110 thereof to release air bubbles within the body of water 180. As is known, this can aerate the body of water 180 to promote aerobic bacterial digestion of the pollutants contained within the body of water 180.

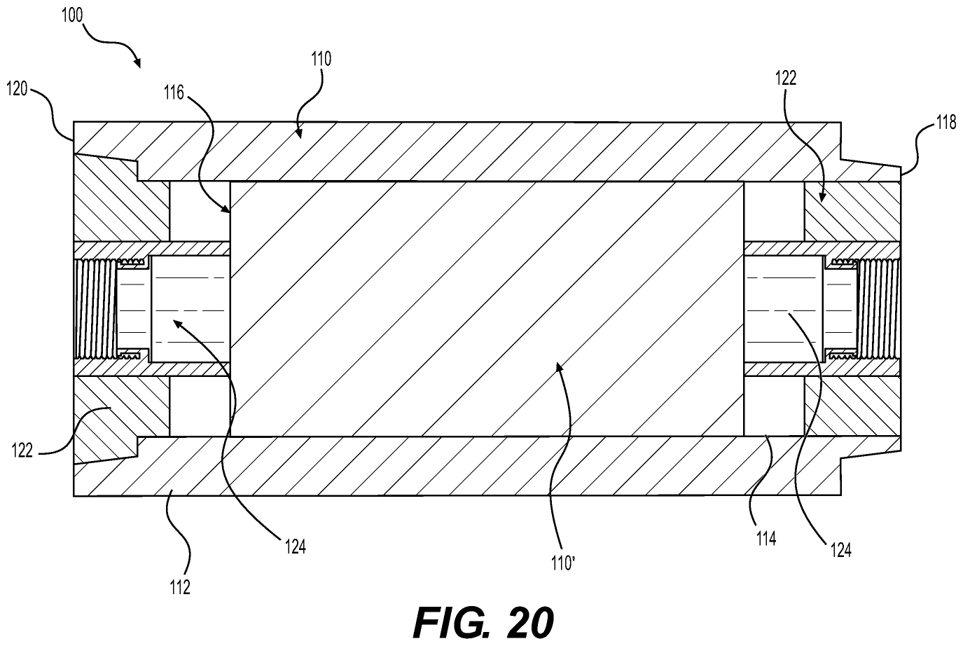

Due to the pervious concrete composition of the mineral membrane 110, a density of the air diffuser 100 is greater than 1 g/cm³ (i.e., denser than water) and the air diffusers 100 are therefore retained in place on the bottom surface 136 without being anchored thereto. In other words, the air diffusers 100 are self-ballasting. This simplifies the installation of the air diffusers 100 in the aeration tank 130, notably in contrast to conventional air diffusers which typically require mechanical anchoring to the bottom surface of the aeration tank. In other embodiments, the density of the air diffuser may be modulated either by adapting the composition or by addition of other components to the air diffuser. For example, in an alternative embodiment illustrated in FIG. 20, the internal passage 116 of the air diffuser 100 is at least partially filled with an inner mineral membrane 110′ (i.e., an inner cementitious porous body) made of a different pervious concrete composition to increase the weight of the air diffuser 100 such as to ensure that the air diffuser 100 remains in place on the bottom surface 136. For instance, in this alternative embodiment, the inner mineral membrane 110′ is generally cylindrical and extends along a majority of the internal passage 116 of the air diffuser 100. In particular, the inner mineral membrane 110′ is in contact with the inner peripheral surface 114 of the mineral membrane 110 (which may thus be referred to as an outer mineral membrane 110). The pervious concrete composition of the inner mineral membrane 110′ is similar to that of the outer mineral membrane 110 but may be modulated to change some properties thereof. For instance, as a result, the inner mineral membrane 110′ may have a different density and/or porosity from the outer mineral membrane 110. In this alternative embodiment, the inner mineral membrane 110′ is formed together with the outer mineral membrane 110, such as by casting.

In some embodiments, the pervious concrete composition of the mineral membrane 110 (and/or the mineral membrane 110′) of the air diffuser 100 may only include the cement binder 20 and the coke 22, while the crushed stone 24 and the synthetic microfibers 26 are omitted from the composition.

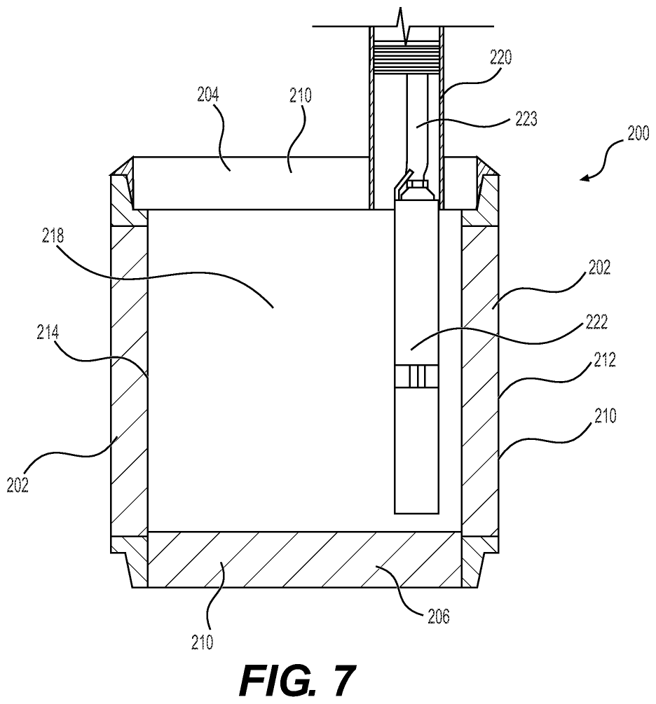

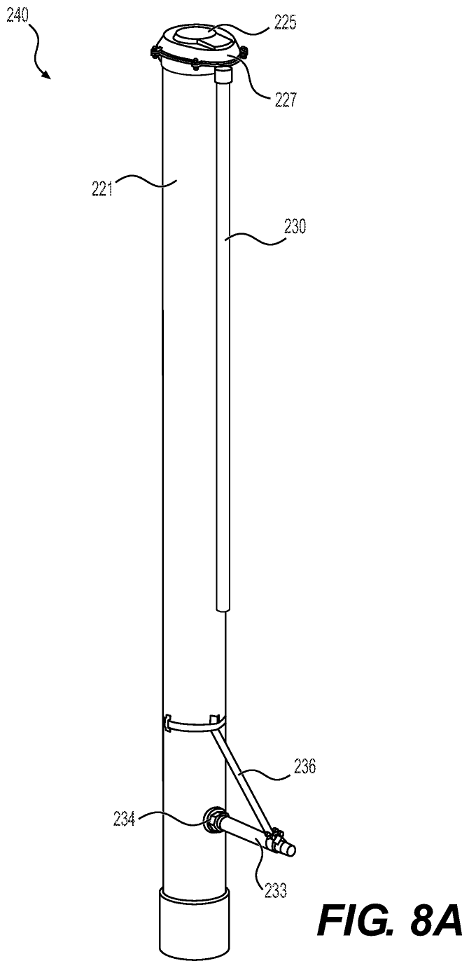

With reference to FIGS. 6 to 12, in another embodiment, a filtering well 200 is provided with a mineral membrane 210 having the pervious concrete composition described above. In particular, the filtering well 200 has a body 202 including a top wall 204, a bottom wall 206 and a peripheral wall 208 extending between the top and bottom walls 204, 206. In this embodiment, each of the walls 204, 206, 208 comprises the mineral membrane 210 such that each of the walls 204, 206, 208 is configured to filter liquid flow into an inner volume 218 of the body 202. In this example, the body 202 is formed as a one-piece component such that the walls 204, 206, 208 are integrally connected to one another. As such, the walls 204, 206, 208 are all made of the mineral membrane 210. In this example, the peripheral wall 208 is generally annular and has an outer peripheral surface 212 and an inner peripheral surface 214 (FIG. 7) which define a thickness of the mineral membrane 210 of the peripheral wall 208. An outlet conduit 220 extends through the top wall 204 and is in fluid communication with the inner volume 218. In particular, in this embodiment, the outlet conduit 220 is cast in the mineral membrane 210 of the top wall 204. The outlet conduit 220 can be made of a polymeric material (e.g., PVC) or a metallic material (e.g., stainless steel). In this example, the outlet conduit 220 is a casing that is directly cast in the mineral membrane 210. It is contemplated that, in other cases, the outlet conduit 220 could be a flexible connector (e.g., a boot-style connector) that is directly cast in the mineral membrane 210.

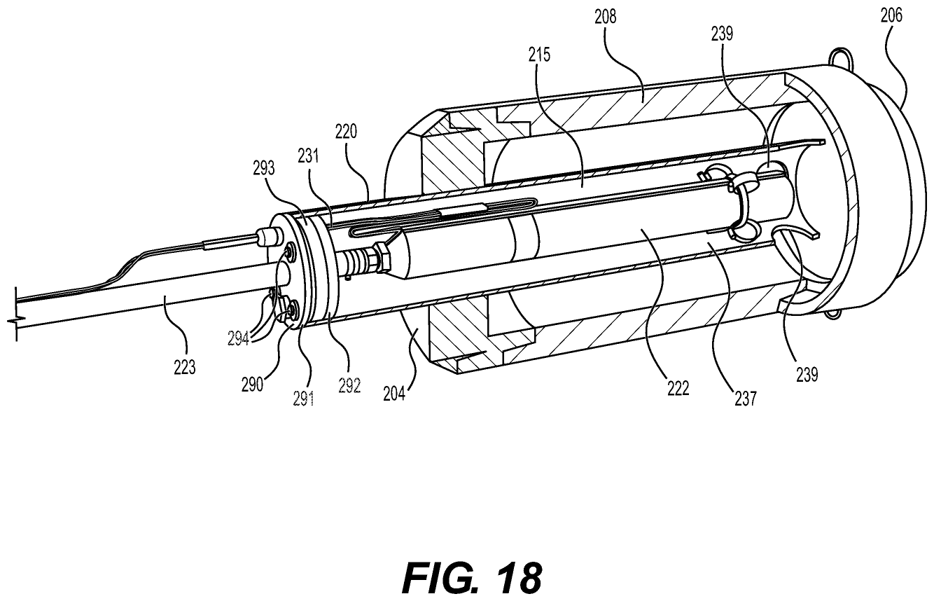

In this embodiment, as shown in FIG. 7, a lower end of the outlet conduit 220 is generally flush with an inner surface of the top wall 204 such that the outlet conduit 220 does not extend substantially within the inner volume 218. However, in some embodiments, as shown in FIG. 18 for example (which shows an alternative embodiment of the filtering well 200 for a different use but the features of which could also be applicable in this embodiment), the outlet conduit 220 could extend from the top wall 204 to near the bottom wall 206 (e.g., abutting the bottom wall 206). In such embodiments, a peripheral conduit wall 237 of the outlet conduit 220 defines a plurality of flow openings 239 for promoting water flow into the outlet conduit 220.

Furthermore, as shown in FIG. 6, in this embodiment, the filtering well 200 has a plurality of guide loops 255 connected to the body 202 for moving the filtering well 200 during installation and/or removal. Notably, the guide loops 255 are used for receiving a sling that allows lifting the filtering well 200. In this embodiment, the guide loops 255 are connected to the mineral membrane 210 by positioning them in the mineral membrane 210 during casting of the peripheral wall 208. As can be seen, in this embodiment, two pairs of guide loops 255 are disposed on opposite sides of the filtering well 200 such that the two pairs of guide loops 255 are diametrically opposite to one another. Each pair of guide loops 255 includes a lower guide loop 255 that is near the bottom wall 206 and an upper guide loop 255 that is near the top wall 204. As such, the upper and lower guide loops 255 are vertically offset from one another. In this embodiment, each guide loop 255 is made of metallic material (e.g., stainless steel). The manner in which the guide loops 255 are used to move the filtering well 200 will be described in detail further below.

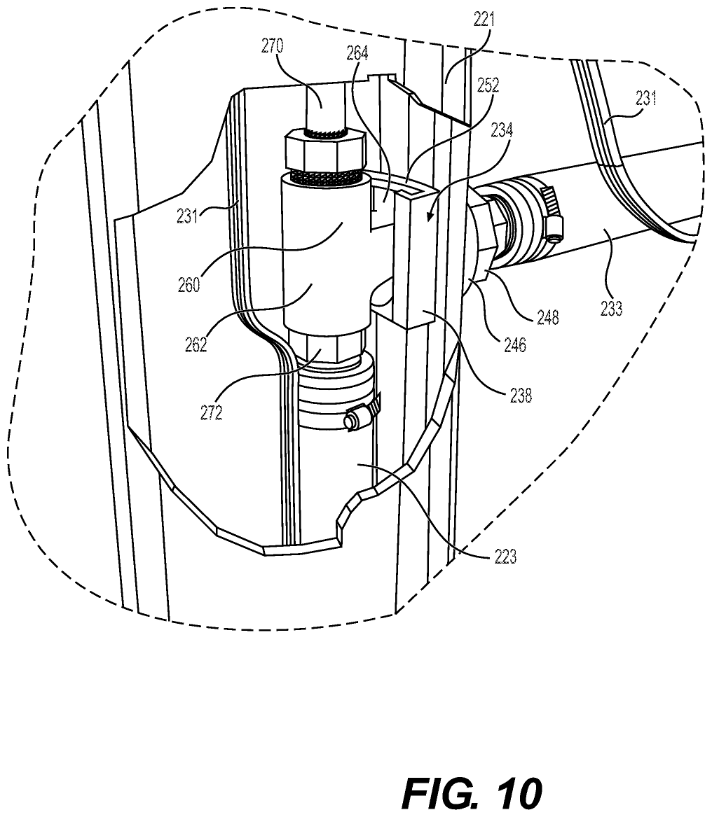

As shown in FIG. 7, in this embodiment, a submersible pump 222 is disposed within the inner volume 218 of the filtering well 200 and is configured to pump water from within the inner volume 218 upwardly into an inner conduit 223 (e.g., a hose) connected to the submersible pump 222 and extending within the outlet conduit 220. Electrical wiring 231 (partially shown in FIG. 10) extends within the outlet conduit 220 and provides power to the pump 222. In embodiments in which the outlet conduit 220 extends substantially within the inner volume 218 of the filtering well 200 (as shown in FIG. 18 for example), the pump 222 may be disposed within the outlet conduit 220.

In other embodiments, instead of the submersible pump 222, a jet pump may be provided which provides suction to cause water within the well 200 to flow up the inner conduit 223. In such embodiments, a check valve which opens and closes based on the pressure generated by the jet pump could be provided at the lower end of the inner conduit 223 (i.e., within the filtering well 200).

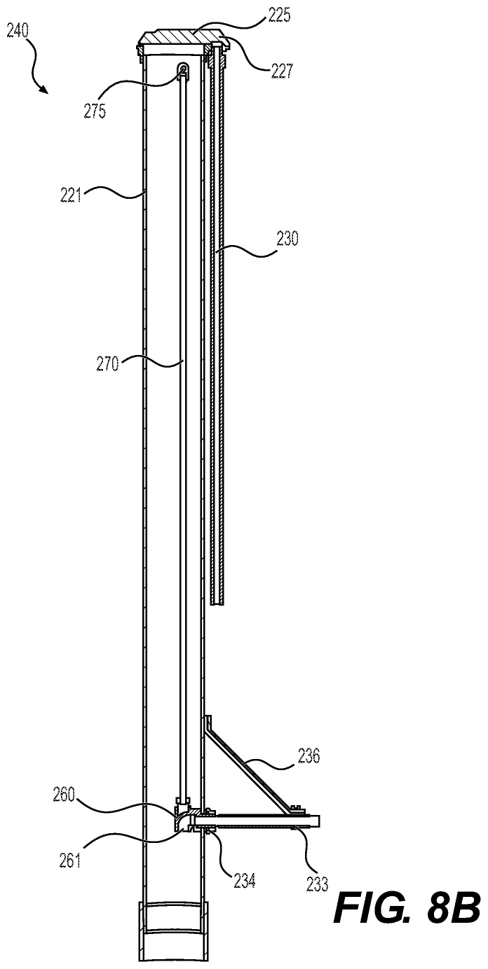

As shown in FIGS. 8A and 8B, a connection kit 240 is provided for installing the filtering well 200 beneath ground. In this embodiment, the connection kit 240 includes a well casing 221, a lockable well cover 225, and an electrical conduit 230. The well casing 221 extends from a lower end to an upper end, and the lockable well cover 225 is disposed at the upper end of the well casing 221 to close off the upper end of the well casing 221. In use, the well cover 225 can be unlocked and removed from the upper end of the well casing 221 in order to access an inner space of the well casing 221. The electrical conduit 230 extends down from an extending portion 227 of the lockable well cover 225 such that the electrical conduit 230 is disposed outside of the well casing 221. The electrical conduit 230 is in communication with the well casing 221 via the lockable well cover 225 which defines a channel (not shown) that communicates the inner space of the well casing 221 and an inner space of the electrical conduit 230.

It is contemplated that the well casing 221 could comprise multiple sections that are connected to one another to form the well casing 221. For example, this may be useful to selectively increase a length of the well casing 221 simply by providing additional well casing sections and connecting them to one another. The connection kit 240 is generally provided such that the well casing 221 has a length sufficient for the filtering well 200 to be positioned below a frost line.

The connection kit 240 also has a diverting conduit 233 configured to route water pumped from the filtering well 200 out of the well casing 221 and toward a distribution point (not shown). In this embodiment, the diverting conduit 233 extends generally at a right angle to the well casing 221 and is connected to a conduit connector 234 that is received in part by an aperture 235 defined by a peripheral wall of the well casing 221. The conduit connector 234 is commonly referred to as a “pitless adapter” and will thus be referred to as such herein. In this embodiment, a reinforcing bracket 236 is connected between the diverting conduit 233 and the peripheral wall of the well casing 221 to provide support to and reinforce the pitless adapter 234 and the diverting conduit 233. In this example, the reinforcing bracket 236 is strapped to the well casing 221 by a metallic band and is fastened to the end of the diverting conduit 233. The reinforcing bracket 236 may reduce the likelihood of the pitless adapter 234 being moved during backfilling of the excavated area in which the filtering well 200 is installed. Moreover, in this embodiment, the diverting conduit 233 is a metallic pipe (e.g., a stainless steel pipe) that is fastened, namely welded, to the reinforcing bracket 236.

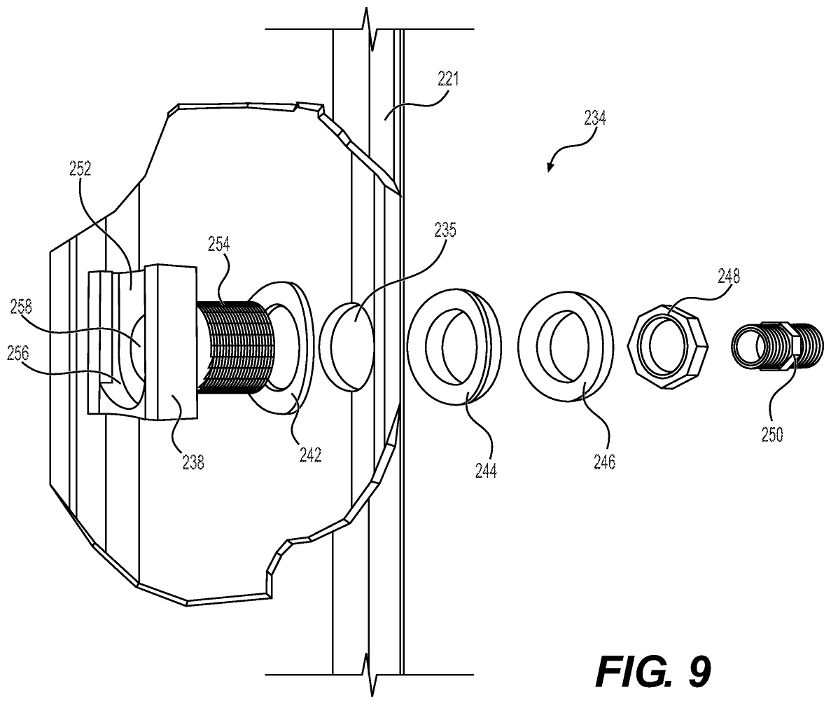

As shown in FIG. 9, in this embodiment, the pitless adapter 234 includes an inner connector member 238 disposed partly inside the well casing 221. The inner connector member 238 has a slide-receiving portion 252 and a protruding portion 254 that extends from the slide-receiving portion 252. The slide-receiving portion 252 is disposed inside the well casing 221 while the protruding portion 254 extends through the aperture 235 such that part thereof extends outside of the well casing 221. The slide-receiving portion 252 defines a sliding recess 256 configured to receive a matching slide which will described further below. An inner conduit 258 is defined by the protruding portion 254 and opens into the sliding recess 256. The pitless adapter 234 also includes inner and outer seal members 242, 244, a washer 246, a nut 248 and a double end fitting 250. The inner and outer seal members 242, 244 form seals between the protruding portion 254 and the well casing 221 on the inside and outside of the well casing 221 respectively. The washer 246 receives the protruding portion 254 therethrough to provide a load distribution surface for the nut 248 which threadedly engages the protruding portion 254 to secure the inner connector member 238 in place. The double end fitting 250 engages an internal thread of the protruding portion 254. As shown in FIG. 10, the diverting conduit 233 is connected to the distal end of the double end fitting 250.

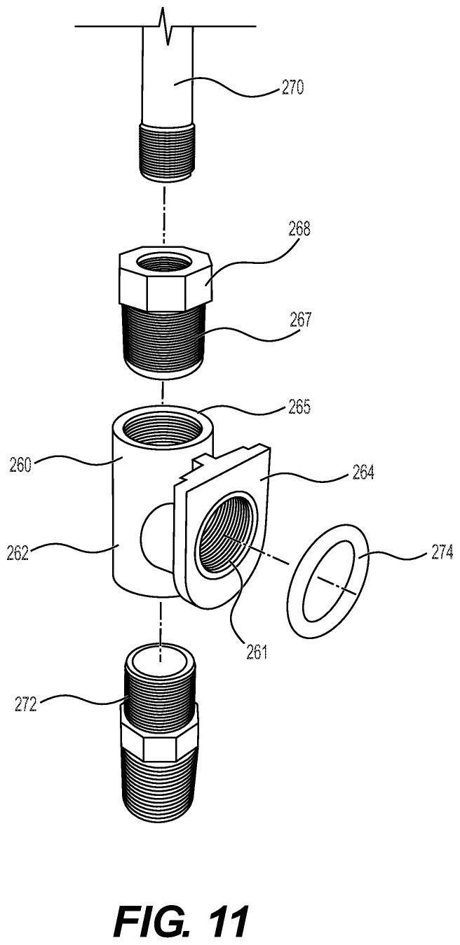

With reference to FIGS. 10 and 11, the pitless adapter 234 also has a diverting connector 260 that includes a connecting body 262 and a slide 264 connected to the connecting body 262. As shown in FIG. 8B, the diverting connector 260 defines an elbow-shaped inner conduit 261 extending from a lower end of the connecting body 262 to an outer end of the slide 264. In use, the elbow-shaped conduit 261 is in fluid communication with the inner conduit 258 of the inner connector member 238. The connecting body 262 has internal threads at an upper end 265 thereof to threadedly receive a lower end portion 267 of an upper fitting 268. In turn, the upper fitting 268 has internal threads at its upper end to threadedly receive a threaded lower end of a handle rod 270 of the connection kit 240. As shown in FIG. 8B, a handle 275 is connected to the upper end of the handle rod 270 for handling by a user. Returning to FIG. 11, a lower end 266 of the connecting body 262 has internal threads to threadedly receive a double end fitting 272 which, in use, interconnects the connecting body 262 to the inner conduit 223 that is fluidly connected to the pump 222 disposed in the filtering well 200.

The slide 264 is shaped and dimensioned to be slidable into and out of the sliding recess 256 of the slide-receiving portion 252. In position within the sliding recess 256, a lower end of the slide 264 is abutted by a lower wall of the slide-receiving portion 252. In this embodiment, the lower end of the slide 264 is generally rounded. As shown in FIG. 11, a sealing member 274 is connected to the slide 264 to form a seal between the slide 264 and the inner connector member 238 when the slide 264 is received in the slide-receiving recess 256. The sliding interaction between the slide 264 and the slide-receiving 252 allows a user to quickly place the diverting connector 260 and components fixedly connected thereto in position as illustrated in FIG. 10 from the upper end of the well casing 221 by handling the handle 275 which is connected to the diverting connector 260 via the handle rod 270. Similarly, the user can quickly retrieve the diverting connector 260 and components connected thereto from the upper end of the well casing 221. As will be appreciated, this may facilitate the user's ability to effect maintenance of the system as he/she does not need to rely on a plumber or a pump technician in order to access the internal components (e.g., the pump 222).

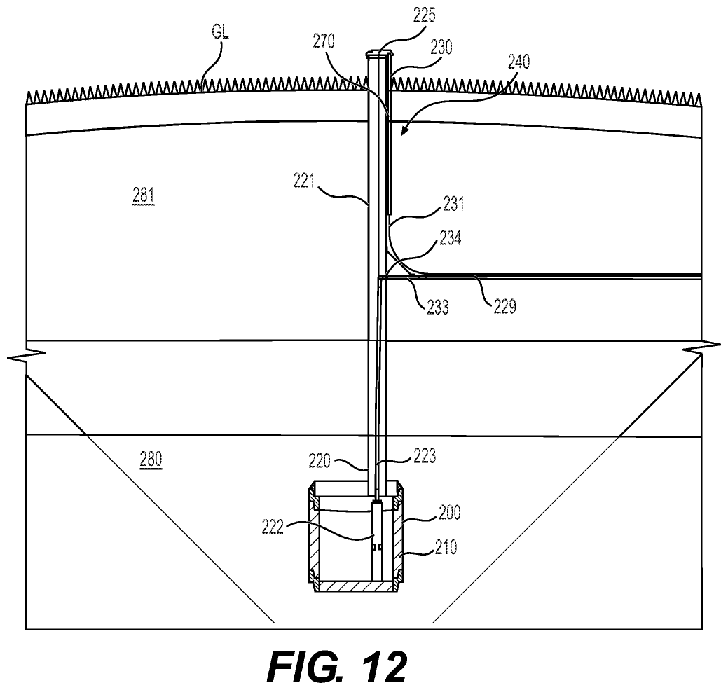

The connection kit 240 may be sold pre-assembled as shown in FIGS. 8A and 8B which may facilitate installation of the filtering well 200 at an installation site (illustrated in FIG. 12). Moreover, in some embodiments, tools and parts required for installation of the connection kit 240 may be provided together with the connection kit 240.

As shown in FIG. 12, in use, the filtering well 200 is positioned within a groundwater layer 280 disposed below ground (i.e., beneath a layer of soil 281). Due to the pervious concrete composition of the mineral membrane 210 described above, water seeps through the mineral membrane 210 and into the inner volume 218, while the mineral membrane 210 filters undesirable particulate material from the water. The connection kit 240 is installed by connecting the inner conduit 223 to the diverting connector 260 placed within the well casing 221, received by the slide-receiving portion 252. The well casing 221, which has a length suitable for the depth at which the filtering well 200 is positioned, is connected to the outlet conduit 220 and thus extends upwardly therefrom. As can be seen, part of the well casing 221 extends above a ground level GL such that the well cover 225 is accessible above ground. An outer hose 229 is connected to the diverting conduit 233 to fluidly connect the filtering well 200 to the distribution point to be serviced by the filtering well 200. As shown in FIG. 12, water can thus be pumped from the inner volume 218 of the filtering well 200 into the inner conduit 223, through the pitless adapter 234 (including the diverting connector 260 and the inner connector member 238), the diverting conduit 233, to the outer hose 229 and to the distribution point. The lockable well cover 225, which covers the upper end of the well casing 221, is removable by a user to access the inside of the well casing 221. With the filtering well 200 installed, the user can remove the submersible pump 222 (or the check valve in case a jet pump is used) and the inner conduit 223 through the well casing 221 by lifting the handle 275 that is accessible through the upper end of the well casing 221. Notably, the slide 264 can be slid out of the slide-receiving recess 256 by pulling the handle 275 (and thereby the diverting connector 260) upward. This can facilitate maintenance of the different internal components including the diverting connector 260 and the pump 222. The pump 222 and the inner conduit 223 can also be easily placed back in position by handling the handle 275 and moving thereby the diverting connector 260 such that the slide 264 engages the slide-receiving recess 256.

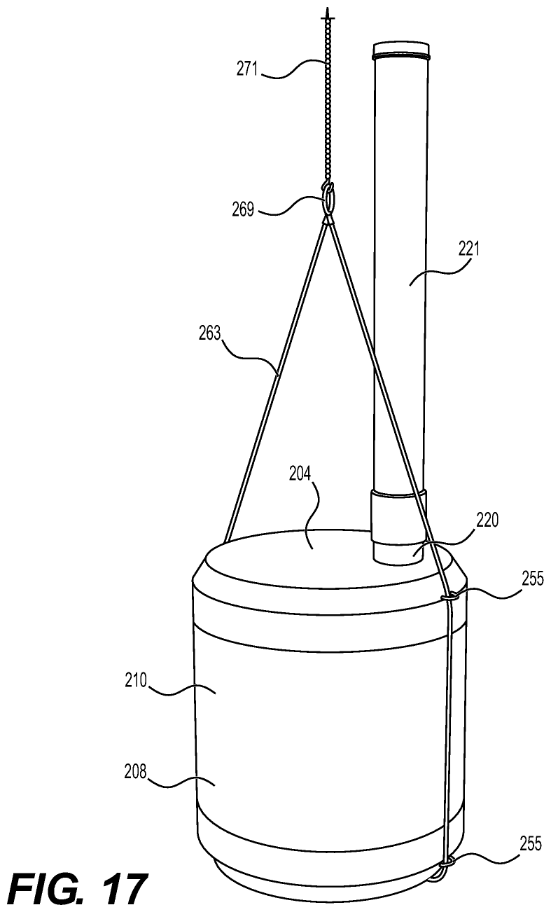

As shown in FIG. 17, in order to install the filtering well 200 at a well site, in this embodiment, a sling 263 is threaded through the guide loops 255 provided on both opposite sides of the filtering well 200 such that the sling 263 passes underneath the bottom wall 206 of the filtering well 200. In this embodiment, the sling 263 is a steel cable having the eyelets 269 at opposite ends thereof. The sling 263 is then connected to a lifting apparatus (not shown) that can hoist the filtering well 200. In particular, in this embodiment, two opposite ends of the sling 263 have respective eyelets 269 which are hooked onto a cable 271 that is connected to the lifting apparatus. The lifting apparatus can be any suitable machine (e.g., an excavator). Once the filtering well 200 is hoisted by the lifting apparatus, it is then lowered onto a support surface (i.e., a ground surface) in an excavated area at the well site. An operator then disconnects the sling 263 from the lifting apparatus, and disengages the sling 263 from the guide loops 255. In particular, the sling 263 can simply be pulled from one end such that the sling 263 slides out of engagement with the guide loops 255. A sufficient amount of clearance from the support surface is typically provided underneath the filtering well 200 such that the sling 263 can be pulled out from underneath the filtering well 200 without significant difficulty. Moreover, the sling 263 is disengaged from the guide loops 255 by an operator positioned at ground level GL (i.e., not within the excavation area) to further facilitate and expedite the installation. In addition, this provides a safe installation method as the operator can avoid going down into the excavation area to remove hoisting equipment (e.g., the sling 263). Notably, the excavation area could be unstable since it reaches the groundwater layer 280 and therefore it is possible that the soil condition causes soil to slide down into the excavation area.

Once the filtering well 200 is in place, it is contemplated that, in some embodiments, the excavated area can be at least partially backfilled with filter sand in order to surround the filtering well 200 with a layer of filter sand. The filter sand may have a porosity of between 20% to 30% inclusively. This may reduce the water flow rate into the inner volume 218 of the filtering well 200 but provide additional filtration by removing smaller particles. In turn, this may additionally help to limit clogging of the mineral membrane 210 of the filtering well 200. Moreover, backfilling the excavated area with filter sand may allow a relatively large volume of water to be contained within voids defined by the filter sand such that this water is readily accessible to infiltrate the filtering well 200.

In an alternative embodiment, illustrated in FIG. 18, the filtering well 200 may be configured to be submerged within a body of water rather than being disposed beneath ground. Thus, in this alternative embodiment, the previously described connection kit 240 is omitted and, instead, the filtering well 200 has a well seal 290 that closes off the outlet conduit 220. The well seal 290 is disposed outside of the inner volume 218 of the filtering well 200, at an exterior end of the outlet conduit 220. In this alternative embodiment, the inner conduit 223, which is in communication with the inner volume 218, extends through the well seal 290. Similarly, the electrical wiring 231 connected to the pump 222 for powering thereof extends through the well seal 290. As will be appreciated, both the inner conduit 223 and the electrical wiring 231 are sealingly engaged to the well seal 290 to prevent unregulated water flow into or out of the filtering well 200 through the outlet conduit 220. In this embodiment, the well seal 290 has two rigid portions 291, 292 and a compressible layer 293 disposed therebetween to separate the rigid portions 291, 292. In this embodiment, the rigid portions 291, 292 are disc-shaped plates (e.g., made of metallic material such as cast iron), while the compressible layer 293 is a disc made of elastomeric material. For instance, in this example, the compressible layer 293 is made of rubber. Fasteners 294 are provided on an exterior side of the well seal 290, namely on the rigid portion 291, in order to secure the seal provided by the well seal 290. Notably, tightening of the fasteners 294 causes the rigid portions 291, 292 to compress the compressible layer 293 in order to secure the seal. It is contemplated that, in other embodiments, the filtering well 200 may not contain a pump and, instead, a jet pump (e.g., an aspiration pump) disposed outside of the filtering well 200 could be fluidly connected to the inner conduit 223.

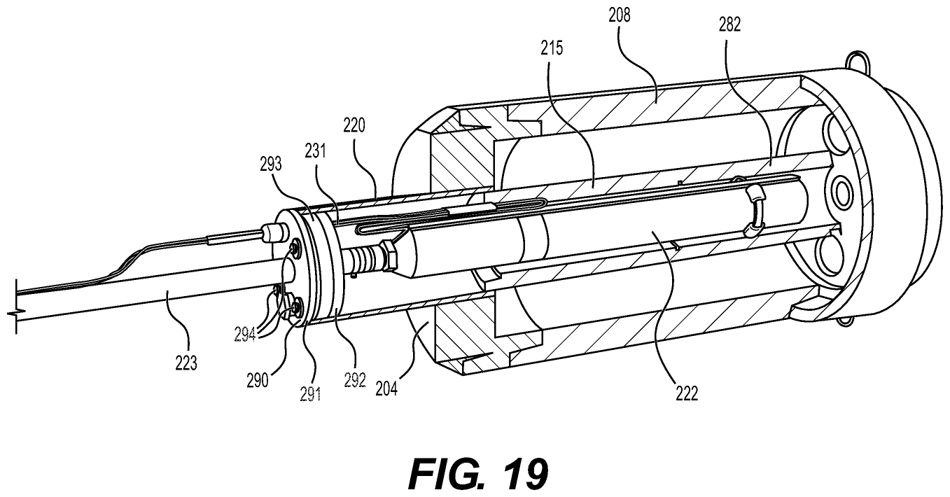

In another alternative embodiment, illustrated in FIG. 19, the filtering well 200 includes an inner peripheral wall 282 that also comprises the mineral membrane 210. In such an embodiment, the peripheral wall 208 may thus be considered an outer peripheral wall. The inner peripheral wall 282 provides an additional layer of filtration for the water that traverses into the inner volume 218 through the outer walls 204, 206, 208 of the filtering well 200. In this embodiment, the inner peripheral wall 282 is concentric with the outer peripheral wall and is generally annular. The inner peripheral wall 282 extends from the top wall 204 to the bottom wall 206. Moreover, as can be seen, in this embodiment, the pump 222 is disposed within an internal space defined by the inner peripheral wall 282.

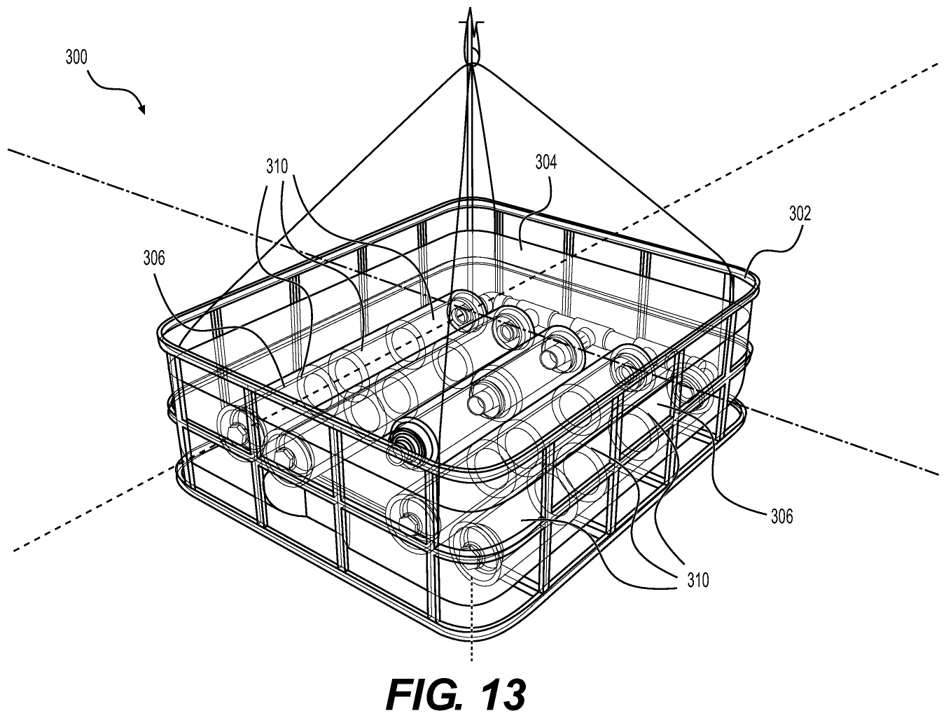

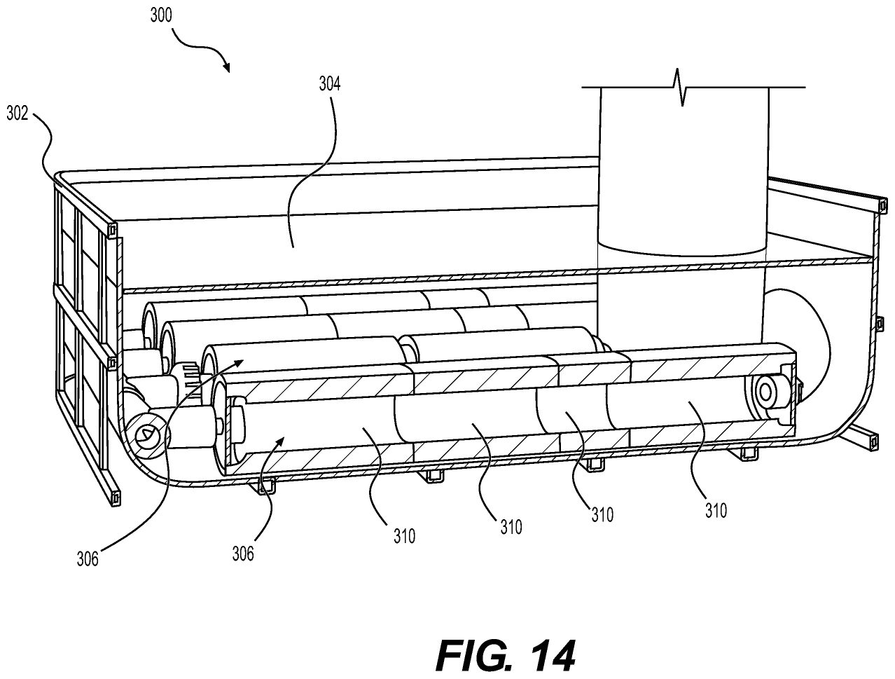

With reference to FIGS. 13 and 14, in another embodiment, a filter bed 300 includes a cage 302 and a plurality of filtering conduits 306 disposed within the cage 302. More particularly, the cage 302 is filled with filter sand 304 (e.g., silica sand) and the filtering conduits 306 are disposed beneath the filter sand 304. As shown in FIG. 14, in this embodiment, each filtering conduit 306 includes a plurality of tubular mineral membranes 310 having the pervious concrete composition described above. The mineral membranes 310 of each filtering conduit 306 are connected in series such that water flowing therethrough flows consecutively within an inner passage of each mineral membrane 310.

In use, an effluent containing particulate pollutants is distributed atop the filter bed 300. The filter sand 304 traps some of the particulate pollutants. A portion of the particulate material that is not trapped by the filter sand 304 makes its way to the filtering conduits 306 which, due to the pervious concrete composition of the mineral membranes 310 thereof, retain the filter sand 304 and the particular pollutants while allowing water to flow through the mineral membranes 310 and into the inner passages formed thereby. The water that flows into the mineral membranes 310 can then be pumped where needed via external piping connected to the filtering conduits 306. A top layer of the filter sand 304 that lies above the filtering conduits 306 can be periodically removed if clogged with particulates. The filter bed 300 may also be backwashed by pumping water through the filtering conduits 306.

The filter bed 300 can be used in different applications. For instance, the filter bed 300 may be used for wastewater sludge thickening, for contaminated soil dewatering, and for vegetable washing effluent treatment. In embodiments in which the filter bed 300 is used underwater (e.g., in a dewatering application), a cover may be added to the cage 302 to divert the effluent.

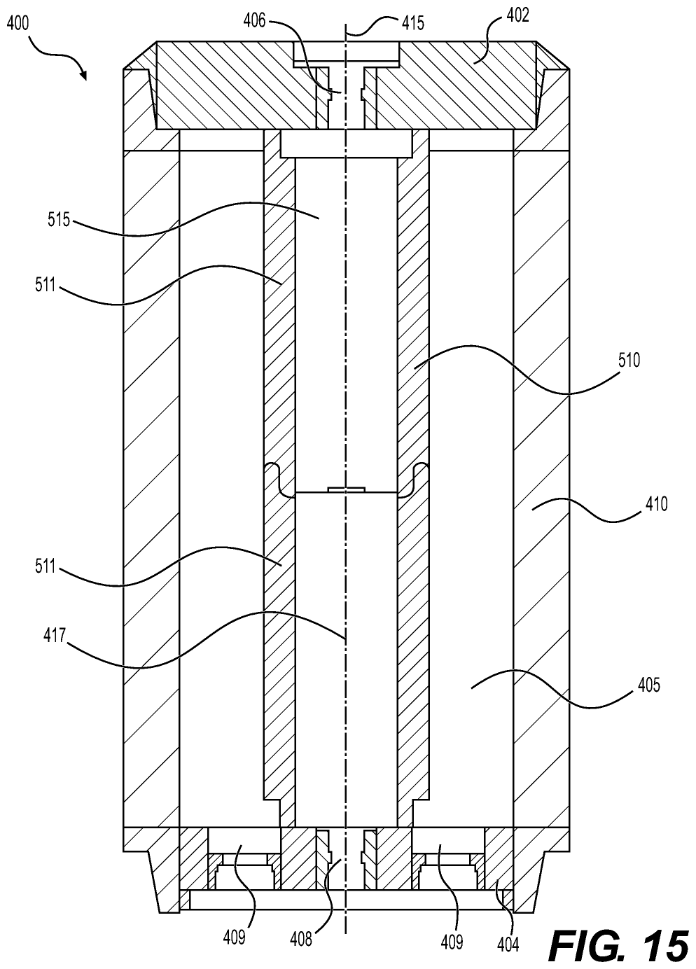

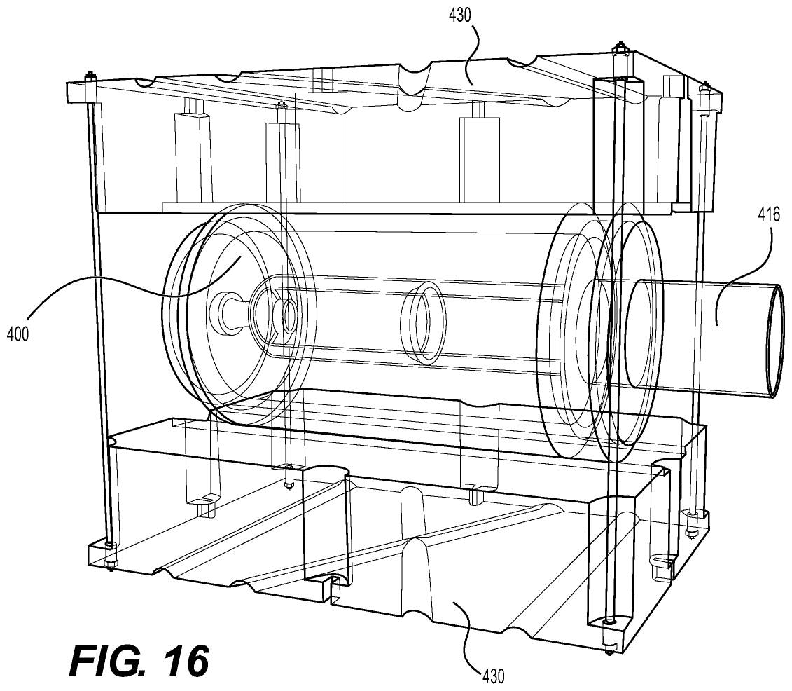

With reference to FIGS. 15 and 16, in another embodiment, a multi filter screen 400 is provided with two layers of concentric mineral membranes 410, 510 having the pervious concrete composition described above. More specifically, the mineral membranes 410, 510 are generally cylindrical and include an outer mineral membrane 410 an inner mineral membrane 510 disposed within the outer mineral membrane 410. The outer and inner mineral membranes 410, 510 are thus concentrically aligned with respect to a common axis 415. As can be seen, a diameter of the outer mineral membrane 410 is greater than a diameter of the inner mineral membrane 510. For instance, in this embodiment, the outer mineral membrane 410 has an outer diameter of approximately 12 inches while the inner mineral membrane 510 has an outer diameter of approximately 4 inches. As such, the outer and inner mineral membranes 410, 510 are spaced apart from one another by an inter-membrane space 405 defined between an inner peripheral surface of the outer mineral membrane 410 and an outer peripheral surface of the inner mineral membrane 510. An inner peripheral surface of the inner mineral membrane 510 also defines an inner passage 515 within which fluid can flow through the inner mineral membrane 510.

In this embodiment, the inner mineral membrane 510 includes two membrane members 511 which are aligned with one another and interconnected to form the inner mineral membrane 510. In other embodiments, the inner mineral membrane 510 may be a single integral component.

The multi filter screen 400 also has first and second end members 402, 404 at opposite ends of the outer and inner mineral membranes 410, 510. The end members 402, 404 enclose the inter-membrane space 405 and the inner passage 515. The first end member 402 defines a central opening 406 (defined by a plastic fitting) that is in fluid communication with the inner passage 515. The second end member 404 also defines a central opening 408 (defined by a plastic fitting) that is in fluid communication with the inner passage 515. Additionally, the second end member 404 defines offset openings 409 that are in fluid communication with the inter-membrane space 405.

In use, the inter-membrane space 405 is filled with filter sand to provide an additional filtering layer. Notably, the multi filter screen 400 can be filled with filter sand via the offset openings 409. Thus, water flowing into the multi filter screen 400 via the outer mineral membrane 410 is subsequently filtered by the outer mineral membrane 410, the filter sand within the inter-membrane space 405 and then by the inner mineral membrane 510. The water entering the inner passage 515 of the inner mineral membrane 510 has thus been filtered by these multiple layers of filters. Moreover, the inner mineral membrane 510 may have a different effective pore size than the outer mineral membrane 410 to filter particulates of different sizes. The filtered water within the inner passage 515 can then be pumped out therefrom via either one of the central openings 406, 408 and a corresponding conduit 416 fluidly connected thereto (FIG. 16).

The multi filter screen 400 can be used for water adduction in bodies of water. For instance, with reference to FIG. 16, in one example of implementation, the multi filter screen 400 can be installed at the bottom of a body of water by placing the multi filter screen 400 between upper and lower floating members 430. The multi filter screen 400 can thus be easily moved to an intended location while floating on the surface of the water. Once the multi filter screen 400 is at the intended location, one of the floating members 430 is opened and filled with water. The multi filter screen 400 and the floating members 430 then sink to a bottom surface of the body of water. The upper floating member 430 acts as a sun-screen to conceal the multi filter screen 400 from sunlight. This may be helpful to limit algae growth on the multi filter screen 400. In some embodiments, legs can be attached to the multi filter screen 400 to elevate the point at which water is adducted from the bottom surface of the body of water. This may be helpful for instance in case there is a muddy deposit at the bottom surface of the body of water.

The multi filter screen 400 may be used in other applications, such as for excavation dewatering for example.

In yet other embodiments, the mineral membrane having the pervious concrete composition described above may be provided as a cylindrical porous body and installed within a draining material. The mineral membrane may thus act as an in-situ filter to remove pollutants from water before their reinfiltration in the surrounding draining material.

In some embodiments, the mineral membrane may be encapsulated within a vessel that has a built-in pressure. The mineral membrane may thus be used under higher pressures.

In other embodiments, the mineral membrane may have any other configuration other than those mentioned above.

Modifications and improvements to the above-described embodiments of the present technology may become apparent to those skilled in the art. The foregoing description is intended to be exemplary rather than limiting. The scope of the present technology is therefore intended to be limited solely by the scope of the appended claims.

What is claimed is:

1. A filtering well comprising:
a body defining an inner volume, the body comprising a mineral membrane made of a pervious concrete composition in order to filter water flow into the inner volume of the body; and
an outlet conduit in fluid communication with the inner volume for discharging water therefrom, the outlet conduit being formed in the mineral membrane of the body.

2. The filtering well of claim 1, wherein:
the body comprises a top wall, a bottom wall and a peripheral wall extending between the top and bottom walls; and
the outlet conduit extends from the top wall.

3. The filtering well of claim 2, wherein:
the outlet conduit extends from the top wall to near the bottom wall; and
the outlet conduit comprises a peripheral conduit wall, the peripheral conduit wall defining a plurality of flow openings.

4. The filtering well of claim 2 or 3, wherein each of the top wall, the bottom wall and the peripheral wall comprises the mineral membrane.

5. The filtering well of any of claims 1-4, further comprising a plurality of guide loops connected to the body for moving the filtering well during installation or removal thereof at a well site, the guide loops being configured to receive a sling for hoisting the filtering well.

6. The filtering well of claim 5, wherein the plurality of guide loops include two pairs of guide loops disposed on opposite sides of the filtering well.

7. The filtering well of claim 6, wherein each pair of guide loops includes a lower guide loop and an upper guide loop vertically generally aligned with the lower guide loop.

8. The filtering well of any of claims 5-7, wherein the guide loops are cast in the mineral membrane.

9. The filtering well of any of claims 1-8, further comprising:
a pump disposed within the inner volume; and
an inner conduit extending within the outlet conduit, the inner conduit being in fluid communication with the pump.

10. The filtering well of any of claims 1-9, wherein:
the filtering well is configured to be submerged in a body of water; and
the filtering well further comprises:
a well seal closing off the outlet conduit; and
an inner conduit in communication with the inner volume and extending through the well seal.

11. The filtering well of claim 1, wherein the body comprises:
a first end wall;
a second end wall;
an outer peripheral wall extending between the first and second end walls, the inner volume of the body being defined by the first end wall, the second end wall and the outer peripheral wall; and
an inner peripheral wall extending between the first and second end walls and disposed within the inner volume,
each of the first end wall, the second end wall, the outer peripheral wall and the inner peripheral wall comprising the mineral membrane.

12. A filtering well system comprising:
the filtering well of any of claims 1-9 and 11;
a well casing fluidly connected to the outlet conduit, the well casing being configured to extend partly above ground; and
a well cover disposed at an upper end of the well casing for selectively closing off the upper end of the well casing.

13. The filtering well system of claim 12, further comprising an inner conduit extending within the outlet conduit and into the well casing, the inner conduit being configured to conduct water out of the inner volume of the filtering well.

14. The filtering well system of claim 13, further comprising:
a diverting conduit disposed outside of the well casing and in fluid communication with the inner conduit;
a pitless adapter fluidly communicating the inner conduit with the diverting conduit, the pitless adapter comprising a first portion disposed within the well casing and a second portion disposed partly outside of the well casing; and
a handle rod connected to the first portion of the pitless adapter and disposed within the well casing, the handle rod being configured to be handled by a user to connect and disconnect the first and second portions of the pitless adapter, the handle rod being accessible to the user by opening the well cover.

15. The filtering well system of claim 14, further comprising a reinforcing bracket connected between the well casing and the diverting conduit to reinforce the diverting conduit.

16. The filtering well system of any of claims 12-15, wherein:
the filtering well further comprises a pump disposed in the internal volume; and
the filtering well system further comprises:
an electrical wiring connected to the pump and extending within the outlet conduit and into the well casing; and
an electrical conduit disposed outside of the well casing and extending downward from the well cover, the electrical conduit being in communication with the well casing via the well cover.

17. The filtering well system of any of claims 12-16, further comprising a layer of filter sand surrounding the filtering well to partially filter water flow into the filtering well and limit clogging of the mineral membrane.

18. A method for installing a filtering well at a well site, comprising:
providing a filtering well having a body comprising a mineral membrane made of a pervious concrete composition, the filtering well comprising a plurality of guide loops connected to the body, the plurality of guide loops including two pairs of guide loops disposed on opposite sides of the filtering well;
threading a sling through both pair of guide loops on the opposite sides of the filtering well such that the sling passes underneath a bottom wall of the filtering well;
connecting the sling to a lifting apparatus;
hoisting the filtering well;
lowering the filtering well onto a support surface in an excavated area;
disconnecting the sling from the lifting apparatus; and
removing the sling from engagement with the guide loops.

19. A pervious concrete composition comprising:
a cement binder;
at least one coarse aggregate including coke; and
a plurality of synthetic microfibers.

20. The pervious concrete composition of claim 19, wherein the coke has pores having an effective pore size of approximately 150 μm.

21. The pervious concrete composition of claim 19 or 20, wherein:
the coke is a first coarse aggregate; and
the at least one coarse aggregate further comprises a second coarse aggregate comprising rock material.

22. The pervious concrete composition of claim 21, wherein the rock material is crushed stone.

23. The pervious concrete composition of claim 21 or 22, wherein a content of the first coarse aggregate over a combined coarse aggregate content including the first and second coarse aggregates is approximately 40%.

24. The pervious concrete composition of any of claims 19-23, further comprising a fine aggregate comprising coke.

25. The pervious concrete composition of any of claims 19-24, wherein the cement binder is Portland cement.

26. The pervious concrete composition of any of claims 19-25, wherein the synthetic microfibers are polypropylene microfibers.

27. The pervious concrete composition of any of claims 19-26, wherein the synthetic microfibers are monofilament microfibers.

28. The pervious concrete composition of any of claims 19-27, wherein the synthetic microfibers have a length between 0.25 inches and 1.5 inches inclusively.

29. A mineral membrane comprising a porous body made of the pervious concrete composition of any of claims 19-28.

30. A mineral membrane for use in filtration, comprising:
a cementitious porous body comprising:
a cement binder;
a plurality of lumps of a coarse aggregate united by the cement binder, the coarse aggregate comprising coke; and
a plurality of synthetic microfibers reinforcing the cementitious porous body,
the cementitious porous body defining a plurality of first pores between the lumps of coarse aggregate and a plurality of second pores defined within the lumps of coarse aggregate,
the first pores having a greater effective pore size than the second pores.

31. An air diffuser for aerating a body of water, the air diffuser comprising:
a cementitious porous body having an outer peripheral surface and an inner peripheral surface, the inner peripheral surface of the porous body defining an internal passage of the air diffuser configured to be fluidly connected to an air source,
the cementitious porous body being made of a pervious concrete composition to allow passage of air flowing within the internal passage through the inner peripheral surface and the outer peripheral surface to aerate the body of water within which the air diffuser is placed, the pervious concrete composition comprising:
a cement binder;
at least one coarse aggregate including coke; and
a plurality of synthetic microfibers for reinforcing the pervious concrete composition.

32. The air diffuser of claim 31, wherein the cementitious porous body of the air diffuser is molded into shape.

33. The air diffuser of claim 31 or 32, wherein the cementitious porous body is generally cylindrical.

34. The air diffuser of any of claims 31-33, wherein:
the cementitious porous body extends from a first end to a second end and defines respective openings at the first and second ends;
the air diffuser further comprises:
a first plug disposed at the first end of the cementitious porous body and partially blocking the opening defined at the first end, the first plug defining a first plug aperture opening into the internal passage; and
a second plug disposed at the second end of the cementitious porous body and partially blocking the opening defined at the second end, the second plug defining a second plug aperture opening into the internal passage.

35. The air diffuser of claim 34, wherein the first plug and the second plug are made of cementitious material.

36. The air diffuser of claim 34 or 35, further comprising:
a first fitting received in the first plug aperture, the first fitting being configured to be removably connected to a first conduit; and
a second fitting received in the second plug aperture, the second fitting being configured to be removably connected to a second conduit.

37. The air diffuser of any of claims 31-36, wherein a density of the air diffuser is greater than 1 g/cm³.

38. The air diffuser of any of claims 31-37, wherein:
the cementitious porous body is an outer cementitious porous body; and
the air diffuser comprises an inner cementitious porous body disposed within the internal passage, the inner cementitious porous body having a pervious concrete composition different from the pervious concrete composition of the outer cementitious porous body.

39. A wastewater treatment system comprising:
an aeration tank configured to contain wastewater therein, the aeration tank having a bottom surface; and
the air diffuser of any of claims 31-38, the air diffuser being retained in place on the bottom surface of the aeration tank without being anchored thereto.

40. The wastewater treatment system of claim 39, further comprising an air compressor fluidly connected to the air diffuser.
